(19) United States
(12) Patent Application Publication
(10) Pub. No.: US 2026/0043429 A1
(43) Pub. Date: Feb. 12, 2026

(54) SCREW FOR DIRECT SCREWING INTO A COMPONENT

(71) Applicant: EJOT SE & Co. KG, Bad Berleburg (DE)

(72) Inventors: Michael ACHENBACH, Breidenbach (DE); Ralf BIRKELBACH, Bad Laasphe (DE); René GERBER, Fronhausen (DE); Jan HACKLER, Bad Berleburg (DE); Ralph J. HELLMIG, Bad Laasphe (DE); Dirk RUNKEL, Bad Laasphe (DE); Frank SCHLOSSER, Marburg (DE); Ilir SELIMI, Siegen (DE); Christoph SINNER, Bad Laasphe (DE); Gerd WEIGEL, Eschenburg (DE)

(21) Appl. No.: 19/102,367

(22) PCT Filed: Aug. 23, 2023
(86) PCT No.: PCT/EP2023/073184

§ 371 Date: Feb. 7, 2025

(30) Foreign Application Priority Data
Aug. 24, 2022 (DE) 10 2022 121 434.6

(51) Int. Cl. F16B 25/00

(52) U.S. Cl. CPC F16B 25/0052; F16B 25/0021; F16B 25/0047; F16B 25/0073

(57) ABSTRACT

A screw for direct screwing comprises a head and a shank. Shank has thread whose outer radius decreases from cylindrical load-bearing region, over tip region, towards tip. Thread has in tip region where thread outer radius diminishes towards screw tip, at least five elevations delimited in circumferential direction and extend in radial direction. Thread in region of elevations extends over changing outer radius, elevation maximum outer radius defines elevation maximum radius of at least two elevations—calibration elevations are of equal size and at the same time is also larger than constant thread outer radius in load-bearing region that is load-bearing region radius. At least three preforming elevations are arranged between calibration elevations and foremost tip, preforming elevations are smaller in respective elevation maximum radius than elevation maximum radius of calibration elevations, and elevation maximum radius of preforming elevations decreases in direction of tip.

The invention relates to a screw for direct screwing into a component, in particular into a component made of a light metal material.

EP 1 053 405 B1 discloses a self-tapping screw with a retaining region and a penetration region which latter the screw thread uses to displace the base material for forming a thread therein. The end of the penetration region facing the screw head forms a calibration region that penetrates only slightly into the base part and is intended to calibrate the thread formed therein. The lowest level between the calibration elevations in this region is at the same thread radius as in the cylindrical load-bearing region. The calibration elevations form two opposite support points that are equidistantly spaced from the screw centerline. There should only be a slight protrusion over the load-bearing diameter.

A similar design is disclosed in WO 95/14863 A1, which teaches a thread-forming screw with forming elements that are arranged on the thread. This screw is intended to reduce the screw-in torque which generally increases with increasing screw-in depth as a thread is being formed in the base material.

In its front region, the screw has forming areas that extend radially beyond a basic thread that runs essentially from the shank to the tip and that are limited in the circumferential direction and relatively short. The aforementioned screw exhibits a calibration elevation in the load-bearing region that protrudes only very slightly beyond the load-bearing thread, in particular by less than 0.08 mm.

Use of the aforementioned screws reduces friction during the tapping process and still achieves a good fastening performance. Reliably producing such calibration elevations, in particular using a rolling method, is difficult because the material required to form the calibration elevation does not become sufficiently available in the rolling process. This means that a defined shaping of the calibration elevation cannot be reliably ensured.

It is the object of the invention to further improve on the fastening performance of the screw while maintaining a low tapping torque, and to make the screw easier to manufacture.

This object is accomplished by the characterizing features of claim 1 in conjunction with the features of its preamble.

In a manner known per se, a screw for direct screwing into a component, in particular into a component made of a light-metal material, comprises a head with a drive and a shank, with a thread being formed on the shank. The thread outer radius of the thread decreases from a cylindrical load-bearing region over a tip region towards the screw tip in such a way that the thread has a smaller thread outer radius at the end remote from the screw head than in its load-bearing region. The tip region begins at the position of the screw closest to the load-bearing region, where the thread outer radius is smaller than the radius of the load-bearing region, and extends up to the tip of the screw.

The thread in the tip region creates a female thread in the base material of the component, into which the thread in the load-bearing region is then screwed.

In its tip region, the thread has at least five elevations that extend in the radial direction. The elevations are limited in the circumferential direction. This means that there is a local minimum between the elevations.

In some areas, the thread outer radius follows a basic thread profile along the helical line. The basic thread profile is interpolated via the local minima, which lie between the elevations, over the tip region. In the region in which the thread coincides with the interpolated section of the basic thread, the thread is referred to as the base thread, which has a base thread outer radius that increases from the screw tip to the load-bearing region radius.

As it were, the base thread runs in the same way as the thread would run without any elevations. The base thread outer radius preferably decreases strictly monotonically, in particular linearly, over the tip region, and in the load-bearing region corresponds to the load-bearing region radius.

The base thread outer radius in the load-bearing region results from the outer diameter of the cylindrical envelope curve in the load-bearing region. The load-bearing region radius is constant over the entire region with which the thread of the load-bearing region engages in the thread pre-tapped by the elevations in the tip region. Thus, according to the invention, no elevations are provided in the cylindrical part of the outer thread any more, as these may adversely affect the screw-in behavior in this region, due to their unreliable manufacturability.

In the tip region, the thread has a thread outer radius in the region of the elevations that changes compared to the base thread outer radius, which thread outer radius is correspondingly larger than the base thread outer radius. Each elevation thus has a maximum thread outer radius in the circumferential direction along the helical line, which corresponds to an elevation maximum radius assigned to an elevation. This ensures an increase and decrease of the thread outer radius over the elevation along the helical line.

According to the invention, at least two elevations are designed as calibration elevations, in which the elevation maximum radius of the calibration elevations is the same size and is at the same time larger than the load-bearing region radius. The maximum radius of the calibration elevations defines the calibration radius.

The at least two calibration elevations make it possible to initially have only the calibration elevation closest to the screw tip provide a tapping action. The at least one calibration elevation located further away will thus provide no tapping action, or only to a significantly reduced extent, until such time as the calibration elevation located closer to the screw tip has worn out. The calibration elevation that follows in the direction of the load-bearing region then takes over the tapping function to the extent of the wear of the calibration elevation closer to the screw tip. This thus allows the load-bearing thread to engage in a thread which is preformed, in an as defined as possible manner, in the component, even over a longer screw-in path and the associated greater tapping performance. This results in a reduced screw-in torque.

Moreover, in the screw according to the invention, the screw-in torque is kept low and within narrow limits, since the calibration elevations will only provide an additional tapping performance once the calibration elevations located closer to the screw tip have become worn out.

The fact that the calibration elevations are located in the region of the decreasing base thread outer radius results in a greater difference from the base thread outer radius than from the load-bearing region radius. Even with a very small difference between the calibration radius, the elevation maximum radius of the calibration elevations and the load-bearing region radius, the calibration elevations can be produced more reliably in this way, as the material for forming the calibration elevations is made available in this way. This difference between the elevation maximum radius of the calibration elevations, i.e. the calibration radius, and the load-bearing region radius is preferably very small, and is in particular less than 0.1 mm.

Preferably, at least three calibration elevations having the same elevation maximum radius may be provided. As a result, there is one calibration elevation located closest to the screw tip, which still provides a low tapping performance, and two additional calibration elevations that are located further away from the screw tip. Once the calibration elevations closest to the screw tip have worn away, the calibration elevations located further away can be used to precisely form the thread in the component. This design provides to be all the more advantageous, the harder the component material, and thus the base material, is.

In addition, at least three preforming elevations are arranged between the calibration elevations and the foremost screw tip, the maximum radius of each of which is smaller than the maximum radius of the calibration elevations, the calibration radius. Moreover, the elevation maximum radius of the respective preforming elevations decreases in the direction of the screw tip. This allows the base material to be shaped progressively. The difference in the elevation maximum radius of successive elevations is preferably selected such that each preforming elevation will provide approximately the same tapping action.

In a preferred embodiment of the invention, the base thread outer radius increases from the screw tip over the tip region in the same way as the maximum radii of the preforming elevations do. In particular, the interpolated course of the elevation maximum radius is parallel to the interpolated course of the local minima.

Preferably, there is a local minimum in the thread outer radius between the load-bearing region radius and the first elevation maximum radius in the direction of the screw tip, at which the thread outer radius is smaller than the load-bearing region radius. This means that the elevation also drops in the direction of the head in front of the load-bearing region to the level of the base thread, which is smaller there in the thread outer diameter than the load-bearing region radius. This means that the first elevation, starting from the load-bearing region in the direction of the screw tip, is located completely in the tip region.

The ratio of the outer thread radius at this first local minimum to the load-bearing region radius is preferably less than 0.996. This ensures a sufficiently large difference in the thread outer radius so that sufficient material is available to form the elevation.

In another advantageous embodiment of the invention, the thread is designed in such a way that a ratio of the percentage protrusion of the calibration radius to a minimum mean value relative to the percentage protrusion of the calibration radius to the load-bearing region radius is greater than 1.4.

The minimum mean value is the mean value of the thread outer radius at the first local minimum and of the thread outer radius at the second local minimum. The first local minimum is located between the load-bearing region and the first elevation closest to the load-bearing region in the direction of the tip, the second local minimum is located between this first elevation and the elevation closest to the tip.

As an alternative to a linear increase in the course of the elevation maximum radius, the increase in the course of the elevation maximum radius in the direction of the head can also be degressive. This allows an adaptation to the tapping behavior and to the hardness of the component material.

The local minima between the elevations can correspond to the base thread outer radius and can decrease continuously, in particular linearly, in the direction of the screw tip over a tapping region, at least part of which extends over the tip region.

If the local minima of the thread outer radius between the elevations correspond to the base thread outer radius, this makes for easier manufacture of the screw and improved screw pull-out forces, as the threads in the thread-forming tip region can thus also contribute to the pull-out strength.

In the radial direction, the thread is limited by a thread crest. As usual, the thread extends with its thread crest along the thread helix, with the position of the points at the thread crest, at which the thread outer radius is determined, changing its angle in the normal plane (outline), which angle is referred to as the circumferential angle.

The circumferential angle thus is the angle that the thread outer radius, which forms an orthogonal to the screw axis on the thread helix, forms with a start orthogonal defined at the free end of the screw, in particular at the start of the thread. Starting from the start orthogonal at the start of the thread, the circumferential angle increases by 360° with each full turn.

In a preferred embodiment of an elevation, at a first circumferential angle position of the elevation circumferential angle, the thread outer radius can correspond to the base thread outer radius. As the circumferential angle increases further, at a circumferential angle position at the maximum of the elevation, the outer thread radius then corresponds to the maximum elevation radius. As the circumferential angle continues to increase, at a circumferential angle position at the end of the elevation, the thread outer radius corresponds to the base thread outer radius. This results in an increase and decrease of the thread outer radius with respect to the base thread outer radius. In this way, an improved load-bearing capacity can already be achieved in the region in which the base thread outer radius is still increasing.

In a preferred further embodiment of an elevation, the thread outer radius increases monotonically starting from the base thread outer radius via an elevation circumferential angle, and then decreases again monotonically up to the base thread outer radius. This allows easy manufacture and yields defined tapping properties of the elevation. In particular, the increase and decrease runs along a parabola which has its vertex at the elevation maximum radius.

The outer radius of the base thread preferably increases linearly in the direction of the head between two elevations running parabolically along the helical line.

In another advantageous embodiment of the invention, the elevation maximum radius of a preforming elevation is greater than the nearest thread outer radius at the start of the elevation which is nearest in the direction of the screw head. At the start of an elevation, the course of the increase in the thread outer radius may have a greater slope than the course of the base thread. This arrangement of the elevations ensures that all preforming elevations only have to provide a tapping action over a partial area—which reduces the tapping torque and the wear of the elevations.

In another advantageous embodiment of the invention, in the plane normal to the screw centerline, between two adjacent elevation maximum radii, the elevation circumferential angle corresponds to an angular distance alpha, with 360°/n−10°<alpha<360°/n+10°, where n is between 2, 3 or 4, and the angular distance of an elevation is less than 210°/n. This defines a relatively short elevation over the elevation circumferential angle, which reduces friction in the area of the elevation maximum radius. This allows the screw-in torque to be reduced.

Not only can the elevations extend outwards in the direction of the outer radius, but they can also have an extent in the longitudinal direction of the screw that is greater than an extent of the base thread in the longitudinal direction of the screw. In particular, this can be the case on both sides.

This also allows the female thread to be progressively increased in width by the preforming elevations at this stage already.

In particular, the length of the thread over the tip region is less than five turns. In this way, especially when the screw is being screwing into a blind hole, the largest possible part of the screw length can contribute to the load-bearing function.

In another advantageous embodiment of the invention, the core diameter increases from the tip over the tip region until it corresponds to the core diameter in the load-bearing region. In this way, the manufacturability of the screw according to the invention can be improved.

The relative increase in the core diameter can be less than the increase in the base thread radius.

The slope of the thread line can preferably be around between 5° and 7°, which corresponds to the increase in the base thread outer radius per turn by between 3% and 5%. This gentle increase, particularly with a proportional increase in the elevation maximum radius, allows the female thread to be formed gradually in the base material.

In another advantageous embodiment, the thread flank width is narrow in the axial direction. The thread has a guide flank facing the screw tip and a load flank facing the screw head. The guide flank and the load flank define a basic flank angle between them. The basic flank angle is preferably between 25° and 45°. This results in an improved screw-in behavior, especially into high-strength light-metal materials.

More preferably, the cross-sectional design of the elevations of the thread across the screw tip is such that they are elliptical in shape at the thread crest.

In a particularly preferred embodiment of the invention, the guide flank and the load flank are thus connected in the region of the elevation via a thread crest whose contour line is elliptical in cross-section. The ellipse has a numeric eccentricity Epsilon of between 0.5 and 1.

Due to the elliptical design of the thread crest in the region of the elevation, a robust form structure can be provided at the outermost thread crest, thus lending it good tapping properties. In addition, the displaced material is subjected to less and less resistance as it progresses from the outermost thread crest in the direction of the thread root to the flank with increasing distance from the apex. This reduces the radial forces required for cutting the base material, which results in easier penetration of the thread into the base material. This also reduces wear of the elevations, which means that a defined formation of the thread in the base material is improved, particularly with regard to the calibration elevations.

In addition to the elliptical shape of the thread crest of the elevations, the thread crests of the base thread in the load-bearing region can also be of elliptical shape. Adapting the shape of the base thread in the load-bearing region will improve the contact of the base thread with the formed female thread. In a particularly preferred embodiment of the invention, the thread is designed in such a way that two tangents intersect at ellipse defining the thread crest, thus forming an intersection angle, i.e. a basic flank angle of less than 60°, in particular of less than 450.

Each of the two tangents lies in a point of contact on the ellipse, which is located at the transition from the elliptical region defining the thread crest to the elliptical region adjoining the thread flank, i.e. a load flank and a guide flank, with each tangent forming a half-flank angle with the large semi-major axis.

The distance of the two points of contact from the semi-major axis is greater than ⅓*tan (half-flank angle)*thread height. The thread height is the difference between the base thread outer radius and half the core diameter. This design achieves a relatively narrow thread flank design.

It is also preferable for the thread crest in the area of the elevation to be designed in such a way that the connecting line from the respective point of contact with the apex of the semi-major axis at the thread crest forms an apex angle with the semi-major axis that is less than 55°. This ensures a correspondingly slender course of the thread crest, thus achieving an improved penetration behavior into the base material.

This results in a contact point on the load flank and a contact point on the guide flank. An orthogonal to the respective tangent through the point of contact intersects the semi-major axis at a point of intersection. The thread crest can preferably be designed in such a way that the distance between the point of contact and the point of intersection is smaller than the distance between the point of intersection and the apex of the thread crest. Preferably, the distance between the point of contact and the point of intersection is less than 90% of the distance from the point of intersection from the apex of the thread crest.

In a particularly preferred embodiment of the invention, the transition from the elliptical thread crest to the thread flank is tangential. This thus makes the transition smooth, and the material displaced by the thread crest can continue to flow along the thread flank with low friction, which can reduce the tapping torque.

Preferably, the ellipse can merge into a straight section of the guide flank and/or the load flank, the latter being congruent with the tangent.

In another embodiment of the invention, the guide flank and/or the load flank can run along an elliptical path, the curvature of which is formed in the opposite direction to the curvature of the ellipse at the thread crest. The curvature can connect directly to the thread crest or to a straight section of the guide flank and/or the load flank.

The eccentricity of the elliptical path of the guide flank and/or the load flank is preferably less than the eccentricity of the ellipse defining the thread crest. This results in a significant widening of the thread in the direction of the thread root, which increases the shear strength and the stability of the thread.

In another advantageous embodiment of the invention, the semi-major axis of the ellipse defining the thread crest is inclined by an angle of up to 100 in the direction of the guide flank relative to the plane normal to the screw centerline.

In particular, the distance between adjacent thread flanks is more than 0.7 times the pitch at 90% of their thread height. Furthermore, the flank width can be less than 0.5 times the thread height at 90% of its thread height. In this way, a sufficiently small thread crest width is provided.

The screw is preferably made of steel.

Additional advantages, features and possible applications of the present invention will be apparent from the description which follows, in which reference is made to the embodiments illustrated in the drawings.

In the drawings,

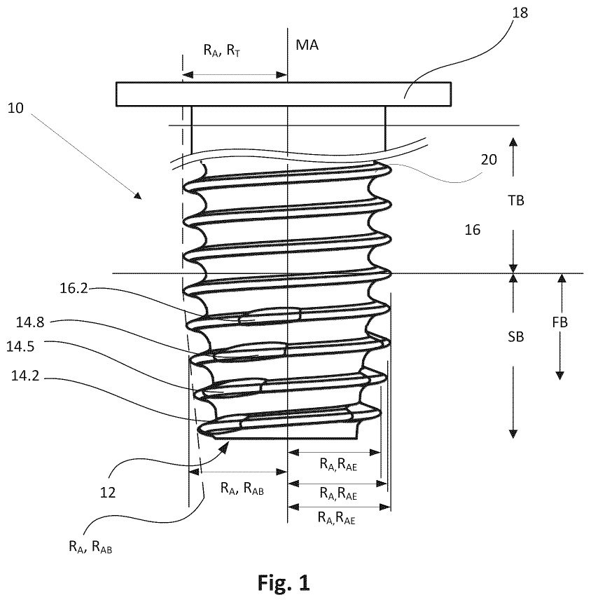

FIG. 1 is a side view of the screw, showing its load-bearing and tip regions;

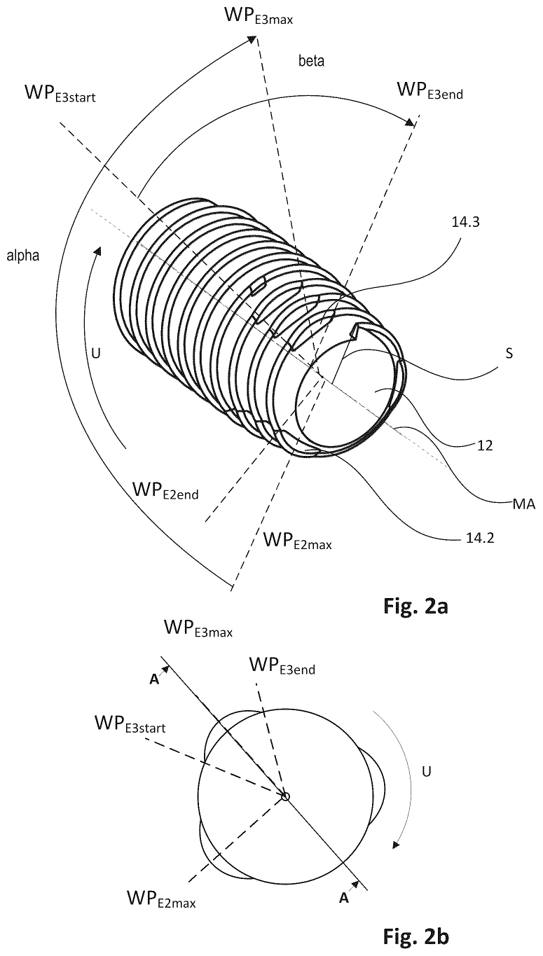

FIG. 2a is a perspective view;

FIG. 2b is a top view of the tip;

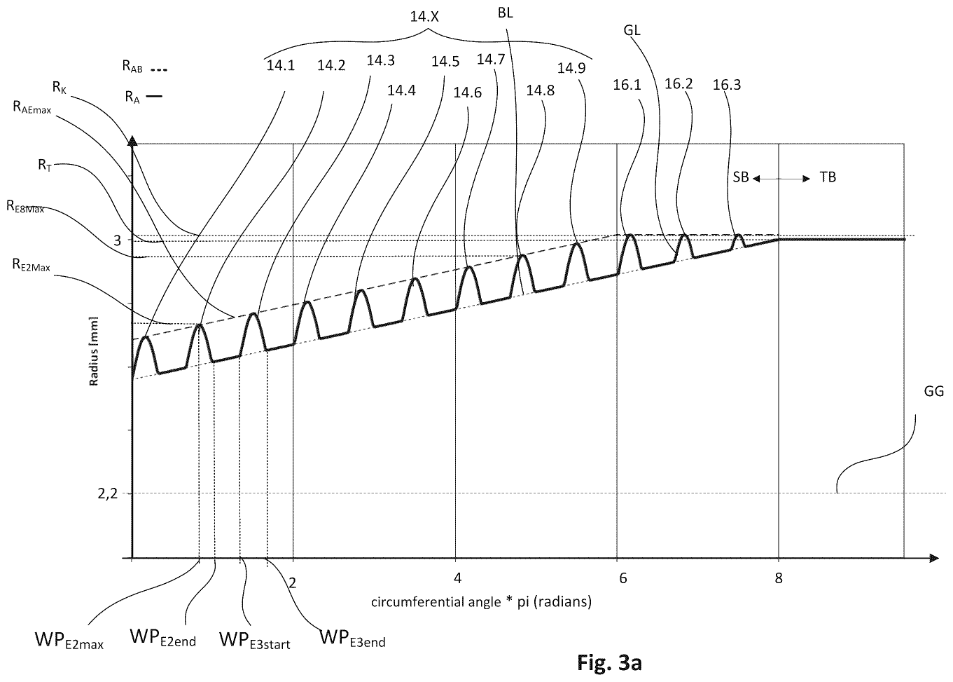

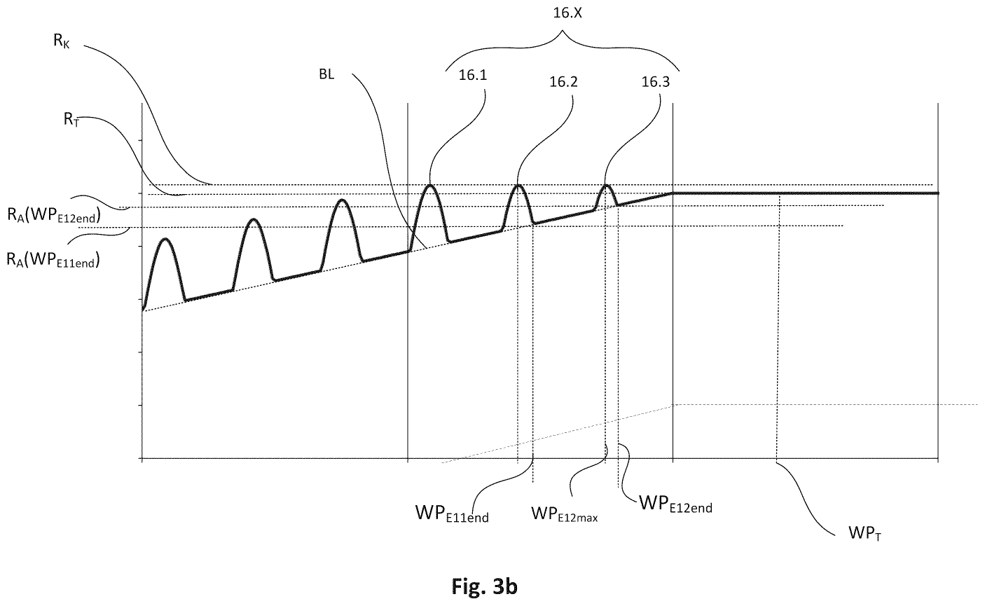

FIG. 3a is a representation of the thread line and the (interpolated) core diameter;

FIG. 3b is an enlarged view of parts of FIG. 3a;

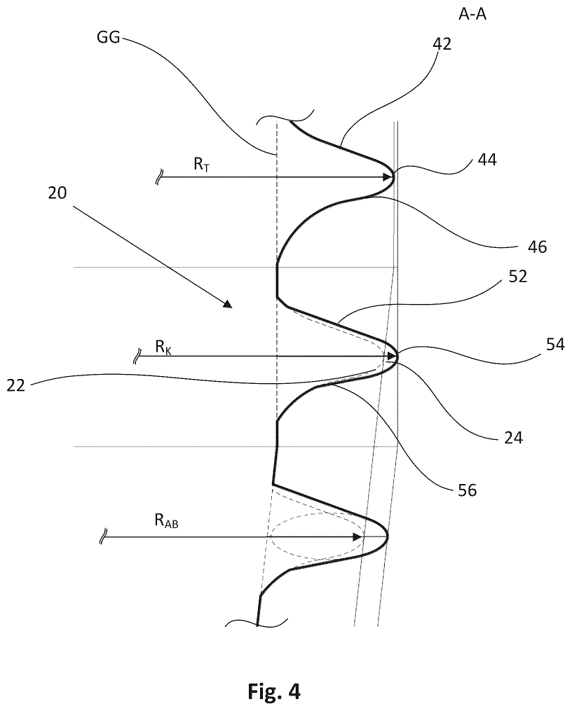

FIG. 4 is a sectional view of details of the thread;

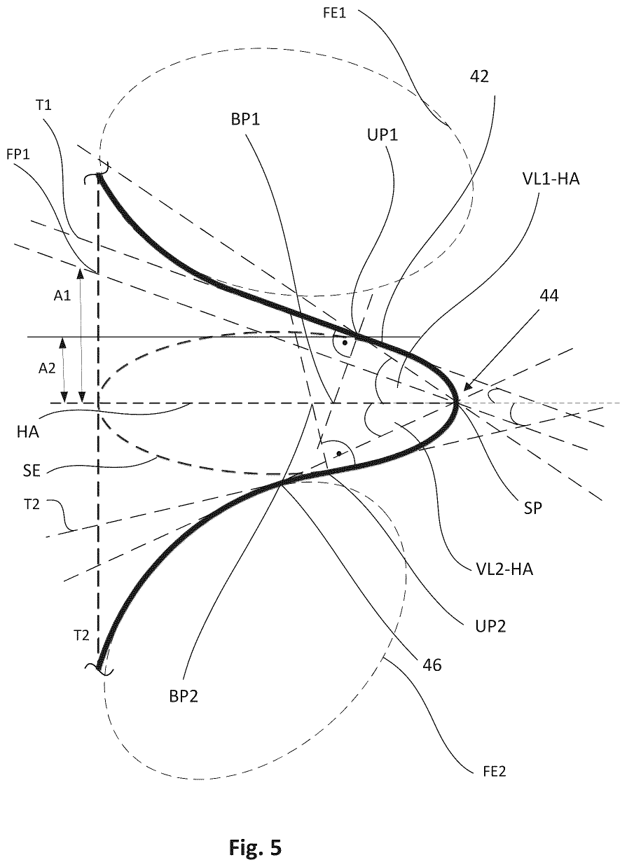

FIG. 5 is a cross-sectional view of the contour of the load-bearing thread; and

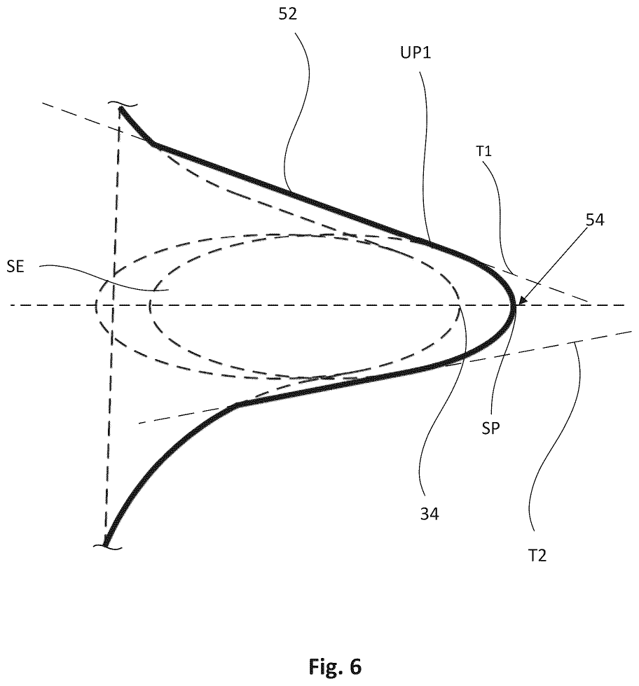

FIG. 6 is a cross-sectional view of the contour of the thread of a calibration elevation.

FIG. 1 is a side view of a screw 10 according to the invention for screwing into a component made of a light-metal material. The screw 10 comprises a front end, referred to as the screw tip 12, and a head 18 located at the other end of the screw 10. The screw has a thread 20 with a load-bearing region TB, with the thread 20, in the load-bearing region TB, having a constant thread outer radius R_{A} over the helical line, namely the load-bearing region radius R_{T}, which corresponds to half the outer diameter in the load-bearing region TB. The load-bearing region radius R_{T} is preferably determined by the nominal outer diameter of the screw. The load-bearing region radius R_{T} thus corresponds to half the nominal outer diameter. The load-bearing region TB is followed in the direction of the screw tip 12 by a tip area SB, over which the thread outer radius R_{A} of the thread 20 varies along the helical line and, as a result, decreases as far as the screw tip 12. In the tip area SB, the thread 20 has elevations 14.2, 14.5, 14.8, 16.1, 16.2 (also referred to as 14.X, 16.X) which are defined in the circumferential direction and extend in the radial direction. In the area of these elevations 14.X, 16.X, the thread 20 has a changing thread outer radius R_{A}. Starting from the screw tip 12, the thread outer radius R_{A} essentially increases and forms a thread 20, which is essentially a base thread with the base thread outer radius R_{AB}, with the base thread outer radius R_{AB} increasing linearly. In addition, the thread has elevations 14.X, 16.X, whose elevation outer radius RAE is larger than the base thread outer radius R_{AB}.

Of the elevations 14.X and 16.X in the tip region SB, at least two of the elevations 16.X have an elevation maximum radius R_{E9max}, R_{E10max}, which is the same for both elevations 16.1, 16.2 and corresponds to the calibration radius R_{K}, which is greater than the load-bearing radius region R_{T}. These elevations are referred to as calibration elevations 16.X, because at least those calibration elevations 16.X located further along the helix in the direction of the head no longer have to perform too much reshaping work to produce the base thread, but instead are intended to ensure that any inaccuracies in the preformed thread, particularly in the region of the thread crest, are reduced. In particular, the aim is to reduce any such inaccuracies that are due to wear of the calibration elevation 16.X located closer to the screw tip 12. This means that the friction of the thread 20 of the load-bearing region TB subsequently screwed into the tapped threads will be low, so that the screw-in torque can be kept low and within narrow limits.

Between the calibration elevations 16.X and the foremost tip 12, at least three preforming elevations 14.X are arranged for tapping, which are smaller in their respective maximum elevation radius R_{E1max}, R_{E8max} than the calibration radius R_{K}. In the present embodiment, eight preforming projections 14.X are provided. Increasing the maximum elevation radius R_{E1max}, up to R_{E8max}, i.e. the thread outer radius R_{A} at the local maximum of the elevation 14.X, over the tip region SB in the direction of the load-bearing region TB, will cause the female thread to be formed with increasing depth into the base material. This increase in the maximum elevation radius R_{E1max} can be seen particularly clearly in the illustration of FIG. 3a, which shows the progression of the increase in the respective maximum elevation radius (there R_{E1max}, up to R_{E9max}), which is marked with the interpolated progression R_{AEMax}.

FIG. 2a is a perspective view of the screw tip 12 of screw 10. Similar to the embodiment of FIG. 1, the thread 20 starts at the screw tip 12 and extends along its helical line in the direction of the head.

Beginning at a starting point S on the thread 20, for example at the start of the thread 20, the angle of the thread radius at the angular position WP_{E2max}, at which the elevation maximum radius of the second preforming elevation 14.2 is located, forms a circumferential angle U with the radius at the starting point in the projection onto the plane normal to the screw centerline MA. The circumferential angle U increases by 360° with each full turn, with the position of the thread outer radius at the respective angular position shifting as the circumferential angle U increases along the screw centerline in the direction of the head. The top view of the normal plane is seen in FIG. 2b.

The circumferential angle distance alpha between the maxima of two adjacent elevations, for example between the angular positions WP_{E2max} and WP_{E3max}, is 120° in the present case, so that there is no offset in the circumferential direction between the elevations that lie on top of each other in the axial direction. Alternatively, the circumferential angle distance alpha between the maxima of two adjacent elevations 14.X, 16.X may also be 125°, for example, so that the elevations are offset in the direction of rotation.

Furthermore, each elevation extends over a circumferential angle distance beta. Each elevation 14.X, 16.X therefore has an angular position WP at which the elevation 14.X, 16.X begins, and another angular position WP at which the elevation ends. For example, the third elevation 14.3 begins at the angular position WP_{E3start} and extends to the end of the third elevation 14.3 at the angular position WP_{E3end}.

Preferably, the circumferential angle distance between two adjacent elevations alpha is more than twice as large as the circumferential angle distance beta of the elevation.

FIG. 3a is a schematic view of an example of the course of a thread line GL at the outermost point of the thread crest over the helical line as it winds its way at the circumferential angle. The general increase in the thread outer radius R_{A} in the direction of the load-bearing region TB can be seen over the tip region SB. The general increase in the base thread outer radius is shown as the base thread line BL as a short dashed line. This line shows the course of a “base thread” the way the thread 20 would run without having the elevations 14.X, 16.X in certain areas.

The solid line shows the course of the actual thread line GL along the base thread and over the elevations that exceed the base thread line in their thread outer radius. The elevations have their local maximum at the elevation maximum radius R_{AEmax}. In this example, the increase in R_{AEmax} over the tip region runs parallel to the base thread line.

In this illustration, it can be seen that the elevations are short in the circumferential direction and only extend over a short angular range of up to about pi/3 (60°). The circumferential angle distance between two elevations, for example between WP_{E2end} and WP_{E3start}, is approximately pi/3 (60°).

The thread has three calibration elevations 16.X in the tip region SB of the screw 10, namely in the area in which, in particular, the thread outer radius R_{A} of the base thread increases continuously, in this case linearly.

The three calibration elevations 16.X have the same elevation maximum radius R_{E10Max}, R_{E11max}, R_{E12Max}, which corresponds to the calibration radius R_{K}. The calibration radius R_{K}, and hence the elevation maximum radius R_{E10Max}, R_{E1max}, R_{E12Max} of the calibration elevations 16.X is greater than the load-bearing thread radius R_{T} of the thread in the load-bearing region TB of the screw.

Since the calibration elevations 16.X are located in the area of the radius increase in the tip region SB, this results in a larger difference between the base thread radius R_{AB} and the calibration radius R_{K} compared to the load-bearing region TB. This means that the calibration elevations 16.X can also be reliably produced with sufficient precision using a rolling method. This then leads to a more reliable reduction in the tapping torque of such a screw as the latter is screwed directly into light metal.

The circumferential extent of the elevation corresponds approximately to, or is preferably smaller than, a circumferential angle distance of 60°. This only causes friction over a small screwing angle, which means that the screw-in torque can be kept low.

FIG. 3b is a view of an enlarged detail of the illustration of FIG. 3a, focusing on the calibration elevations 16.X. This enlarged detail clearly shows that the difference in the outer radius to the base thread BL is significantly greater even at the elevation closest to the load-bearing region TB than would be the case in the load-bearing region TB, where the difference would only be R_{K}-R_{T} and which, according to the invention, is preferably less than 0.1 mm.

According to the teaching of the invention, this allows precise manufacture of the calibration elevations 16.X also in a rolling process in order to achieve the most defined possible shaping of the base material female thread.

Between the calibration elevation 16.3 closest to the load-bearing region and the load-bearing region itself, the thread outer radius R_{A} at the circumferential angle position WP_{E12end} has a local minimum with the thread outer radius R_{A}(WP_{E12end}).

The ratio of the thread outer radius R_{A}(WP_{E12end}) at this local minimum to the load-bearing region radius R_{T} is preferably less than 0.996.

Furthermore, at the end of the second calibration elevation 16.2, i.e. at the circumferential angle position WP_{E11end}, there is another local minimum with the thread outer radius R_{A}(WP_{E11end}).

In particular, the thread is designed in such a way that the ratio of the percentage protrusion of the calibration radius R_{K} over a minimum mean value to the percentage protrusion of the calibration radius RK over the load-bearing region radius R_{T} is greater than 1.4.

The minimum mean value is the mean value of the thread outer radius R_{A}(WP_{E12end}) at the first local minimum and the thread outer radius R_{A}(WP_{E11end}) at the second local minimum.

The design of the thread therefore satisfies the formula:

$$( {R}_{K} / ( {R}_{A} ( {WP}_{E 12 end} ) + {R}_{A} ( {WP}_{E 11 end} ) ) / 2 ) ) - 1 ) / ( ( {R}_{K} / {R}_{T} ) - 1 ) > 1.4$$

The extent of the elevation in the axial direction is shown in FIG. 4.

FIG. 4 is a schematic sectional view A-A through a thread 20 in the transition from the load-bearing region TB to the tip region SB. Starting from its thread base line GG, the thread 20 has a thread flank facing the head in the region of the calibration elevation a load flank 52, which merges into a thread crest 54 having an elliptical contour. Then, in the direction of the screw tip, the thread tip 54 changes back into a thread flank, namely a guide flank 56. The contour of the base thread, as it would be in the sectional plane if there were no elevation, is indicated with a dashed line. In the load-bearing region TB, the actual course then corresponds to that of the base thread, including a load flank 42, a thread crest 44 and a guide flank 46.

Delimited in the circumferential direction, a calibration elevation 54 protrudes beyond the course of the base thread. At its local maximum, the calibration elevation has the elevation maximum radius R_{AEmax}, which in this case corresponds to the calibration radius R_{K}. As is seen in FIG. 4, in deviation from the course of the base thread shown in the form of a dashed line, the elevation also extends beyond the base thread in the axial direction, with the elevation preferably also being rolled on during a rolling process.

As can also be seen in FIG. 3b, at the angular position WP_{E12max}, i.e. in the area in which the base thread height still increases, there is a significantly greater difference between the base thread and the calibration height R_{K} than would be the case in the load-bearing region TB compared to the load-bearing region radius R_{T}. This allows the elevation 54 to be produced in a more reliable manner.

The base thread has an elliptically shaped thread crest 44 in the load-bearing region. The design of the thread crest is illustrated in more detail in FIG. 5.

The thread crest 54 is elliptical in cross-section, the design and effect of which is described in more detail with reference to FIG. 6.

The improved resistance of the elliptical thread crest to wear in combination with the design of the calibration region in the tip area according to the invention enables particularly reliable, precise shaping of the female thread.

The elliptical contour of the thread crest in the load-bearing region is particularly suitable for adapting to the cross-sectional shape of the elevation, which increases the contact surface in the tightened state, which in turn can increase the pull-out forces. The shape of the thread crest of the elevation is similar to that of the base thread, as described in detail below with regard to FIG. 6.

FIG. 5 is a cross-sectional view of the thread in the load-bearing region TB with the elliptically shaped thread crest 44. This thread form is essentially also present in the base thread over the tip region SB of the screw, i.e. in the area between the elevations.

The cross-sectional contour of the thread crest 44 is in the shape of an ellipse SE. In the direction of the screw tip, the thread crest 44 turns into a guide flank 46, and in the direction of the screw head, it turns into a load flank 42. The apex SP of the thread crest lies at the apex of the ellipse SE at its intersection with its semi-major axis HA.

At a transition point UP1, the thread crest 44 transitions into the load flank 42, and at a transition point UP2, it transitions into the guide flank 46. The transition points UP1 and UP2 are the points at which the thread contour leaves the elliptical path SE defining the thread crest 44.

A tangent T1, T2 each can be created at the transition points UP1 and UP2, which defines the flank angle.

The tangent T1, which forms the load flank angle LF with the semi-major axis HA, is located at the transition point UP1.

An orthogonal to the tangent through transition point UP1 intersects the semi-major axis at an intersection point BP1. The thread crest is preferably designed in such a way that the distance between the intersection point BP1 and the transition point UP1 is less than 90% of the distance between the apex SP and the intersection point BP1. This ensures sufficient curvature of the thread crest for a good material flow during displacement, so that wear of the thread crest is reduced during the tapping process.

Furthermore, the thread crest is preferably shaped in such a way that the connecting line VL1 of the transition point UP1 with the apex SP forms an apex angle VL1-HA with the semi-major axis HA. This apex angle VL1-HA is in particular less than 45°, in the present embodiment, it is approximately 22°.

The thread crest 44 is designed in such a way that the relationships that apply to the UP1 also apply to the UP2 of the guide flank.

The tangent T2, which forms the load flank angle FF with the semi-major axis HA, is located at the transition point UP2.

An orthogonal to the tangent T2 through transition point UP2 intersects the semi-major axis at an intersection point BP2. The thread crest is preferably designed in such a way that the distance between the intersection point BP2 and the transition point UP2 is less than 90% of the distance between the apex SP and the intersection point BP2. This ensures sufficient curvature of the thread crest for a good material flow during displacement, thus reducing wear of the thread crest during the tapping process.

Furthermore, the thread crest is preferably shaped in such a way that the connecting line VL1 of the transition point UP2 with the apex SP forms an apex angle VL1-HA with the semi-major axis HA. This apex angle VL2-HA is in particular less than 45°, in the present embodiment example it is around 22°.

Furthermore, a base flank angle can be determined, which results from the sum of the load flank angle LF and the guide flank angle FF. In the present embodiment, this base flank angle is 35°.

The thread is preferably designed so that a parallel to the tangent T1 through the apex intersects the thread base line at a base point FP1. According to the invention, the distance A1 of the base point FP1 to the semi-major axis is at most three times as large as the distance A2 of the transition point UP1 to the semi-major axis.

In the embodiment described, the thread is designed in such a way that the distance A1 is approximately double as large as the distance A2 of the transition point to the semi-major axis HA. This allows a slender shape of the thread to be achieved.

In the present embodiment, the flank profile of both the guide flank 46 and the load flank 42 is at least partially determined by elliptical contours. These flank ellipses FE1, FE2 are of significantly lower eccentricity than the ellipse SE defining the thread crest.

FIG. 6 is a thread cross-section of a further thread form in the tip area SB of the screw 10, in which the thread crest 54 of the thread region is shown in the region of an elevation. An elliptical thread crest 54 leads to improved tapping properties, thus reducing wear of the calibration elevations designed in this way. Furthermore, the elevation contour is shown opposite the thread cross-section of the base thread with its thread crest 34, as this thread would be at the intersection line through the thread with the elevation if the base thread had a uniformly increasing course at this point.

Here, the apex SP is spaced from the screw centerline by the elevation maximum radius at the respective elevation.

The course along the tip ellipse is similar to the course of the tip ellipse as shown in FIG. 5.

Since, in its load-bearing region, the thread has the same contour as the base thread, the tangent T1 to the load flank lies on the ellipse defining the thread crest in the transition point UP1 to the load flank in the area of the elevation parallel to the tangent T1 to the ellipse in the transition to the load flank in the load-bearing region TB. Both therefore form the same load flank angle with the semi-major axis HA. The same applies to the tangent T2 in the same way in relation to the guide flank.

In this respect, the cross-sectional contour of the elevation essentially corresponds to the contour in the load-bearing region. Only the area in which the thread flank follows the tangents T1, T2 is longer in the elevation. As a result, a thread is pre-tapped that is larger than the load-bearing region in which the thread can engage in the load-bearing region with flank regions parallel to the pre-tapped female thread.

The calibration elevation located closest to the load-bearing region is also designed in the same way, although the difference between the base thread and the elevation is greater than the difference between the thread in the load-bearing region and the elevation. This ensures reliable manufacture of the elevations, while still producing a slightly larger pre-formed female thread.

### LIST OF REFERENCE SIGNS

10 screw
12 tip
14.X preforming elevation
16.X preforming elevation
20 thread
22 thread cross-section
24 base thread
34 thread crest
36 guide flank
42 load flank
44 thread crest
46 guide flank
52 load flank
54 thread crest
56 guide flank
A1 distance foot point
A2 distance contact point
GG thread base line
T tangent
HA semi-major axis
SE ellipse (tip)
FE1, FE2 ellipse (flank)
SB tip region
FB tapping region
TB load-bearing region
VL1, VL2 connecting line
GL thread line
BL base thread line
V preforming elevation
K preforming elevation
SP apex
UP1, UP2 contact point
BP1, BP2 intersection point
FP1 foot point
R_{K} calibration radius
R_{A} thread outer radius
R_{AB} base thread radius
R_{T} load-bearing region radius
R_{Emax} elevation maximum radius
U circumferential angle
MA centerline

1-29. (canceled)

30: A screw (10) for direct screwing into a component, in particular made of a light-metal material, comprising
a head, and
a shank,
wherein the shank is provided with a thread (20), the thread outer radius (R_{A}) of which decreases starting from a cylindrical load-bearing region (TB) having a constant load-bearing region radius (R_{T}), over a tip region (SB), towards the screw tip (12),
the thread (20) comprises, in its tip region (SB) that is the region in which the thread outer radius (R_{A}) diminishes towards the screw tip (12), at least five elevations (14.X, 16.X) that are delimited in the circumferential direction and that extend in the radial direction,
the thread outer radius (R_{A}) changing in the region of the elevations (14.X, 16.X) such that an elevation maximum radius (R_{E1max}; R_{E2max}, R_{E8max}) results which is associated with an elevation,
the respective elevation maximum radius (R_{E11max}, R_{E12max}) of at least two elevations—calibration elevations (16.X)—is of equal size and corresponds to a calibration radius (R_{K}) which is larger than the load-bearing region radius (R_{T}),
at least three preforming elevations (14.X) is arranged between the calibration elevations (16.X) and the foremost screw tip (12), which preforming elevations (14.X) are smaller in their respective elevation maximum radius (R_{AEmax}) than the elevation maximum radius (R_{AEmax}) of the calibration elevations (16.X), and moreover the elevation maximum radius (R_{AEmax}) of the preforming elevations (14.X) decreases in the direction of the screw tip (12).

31: The screw according to claim 30, wherein between the load-bearing region radius (R_{T}) and the first elevation in the direction of the screw tip (12), there is a local minimum in the thread outer radius (R_{A}), which is smaller than the load-bearing region radius (R_{T}).

32: The screw according to claim 31, wherein the ratio of the thread outer radius (R_{A}(WP_{E12end})) at the first local minimum to the load-bearing region radius (R_{T}) is less than 0.996.

33: The screw according to claim 31, wherein the thread is designed such that a ratio of the percentage protrusion of the calibration radius (R_{K}) to a minimum mean value ((R_{A}(WP_{E12end})+R_{A}(WP_{E11end}))/2) to the percentage protrusion of the calibration radius (R_{K}) to the load-bearing region radius (R_{T}) is greater than 1.4, with the minimum mean value being divided by the mean value of the thread outer radius (R_{A}(WP_{E12end}) at the first local minimum between the load-bearing region and the first calibration elevation (16.3) and the thread outer radius R_{A}(WP_{E11end}) is formed at the second local minimum between the first calibration elevation (16.3) and the second elevation (16.2).

34: The screw according to claim 30, wherein, starting from the tip (12), over the tip area, the respective elevation maximum radius (R_{AEmax}) of the preforming elevations (14.X) increases in the same way as the thread outer radius (R_{A}) increases at the local minima between the preforming elevations (14.X).

35: The screw according to claim 30, wherein the elevation maximum radius (R_{AEmax}) increases degressively starting from the screw tip (12).

36: The screw according to claim 30, wherein, in an elevation (14.X, 16.X) at a first circumferential angle position (WP_{EXstart}) of a circumferential angle (U), the thread outer radius (R_{A}) is at the level of the base thread outer radius (R_{AB}), on further increase it corresponds to the elevation maximum radius (R_{AEmax}), and, as it increases even further, it corresponds again to the base thread outer radius (R_{AB}) at the corresponding circumferential angle position (WP_{EXend}) of the circumferential angle (U) at the end of the elevation.

37: The screw according to claim 36, wherein, in an elevation (14.X, 16.X), the thread outer radius (R_{A}) increases continuously over a circumferential angle distance (beta) starting from the base thread outer radius (R_{AB}), and then decreases again until it once more corresponds to the base thread outer radius (R_{AB}), in particular follows a parabolic course.

38: The screw according to claim 37, wherein, between two adjacent preforming elevations (14.X), starting from the screw tip, the base thread outer radius (R_{AB}) increases linearly.

39: The screw according to claim 30, wherein the load-bearing region radius (R_{T}) is more than 90% of the calibration radius (R_{K}).

40: The screw according to claim 30, wherein the calibration radius (R_{K}) is at most 0.1 mm greater than the load-bearing region radius (R_{T}).

41: The screw according to claim 30, wherein the elevation maximum radius (R_{AEmax}) of a preforming elevation is greater than the nearest thread outer radius (R_{A}) at the start of the nearest elevation in the direction of the head (18).

42: The screw according to claim 30, wherein the circumferential angle (U) in the plane normal to the screw centerline between two adjacent elevation maxima is equal to a circumferential angle distance (alpha), with 360°/n−100<alpha<360°/n+10°, where n is between 2, 3 or 4, and the angular distance (beta) of an elevation is less than 210°/n.

43: The screw according to claim 30, wherein the elevations (14.X, 16.X) also extend beyond the base thread in the axial direction, in particular on both sides.

44: The screw according to claim 30, wherein the length of the thread (20) over the tip region (SB) is less than five turns.

45: The screw according to claim 30, wherein the pitch of the thread line is between about 5° and 7°, which corresponds to an increase of the base thread outer radius per turn by between 3% and 5%.

46: The screw according to claim 30, wherein, starting from the tip (12), the core diameter (D_{K}) increases over the tip region (SB).

47: The screw according to claim 46, wherein, starting from the screw tip (12) in the direction of the head, the relative increase in the core diameter (D_{K}) is less than the increase in the base thread radius (R_{AB}).

48: The screw according to claim 30, wherein the thread flank width is narrow in the axial direction, and the thread has a guide flank (46, 56) facing the screw tip (12) and a load flank (42, 52) facing the screw head (18), which flanks in particular form between them a base flank angle of 30°.

49: The screw according to claim 30, wherein the guide flank (46, 56) and the load flank (42, 52) are connected via a thread crest (44, 54), with the profile contour line of the thread crest (44, 54) following an elliptical path.

50: The screw according to claim 49, wherein the thread crest (44, 54) of the load-bearing region (TB) and/or of the elevation in the tip region (SB) is designed in such a way that the tangent (T1) to the ellipse at the point of contact (UP1) in the transition to the load flank (42, 52) forms a load flank angle (LF) with the semi-major axis (HA) of the ellipse which is less than 30°, in particular less than 25°, and in that the tangent (T2) to the ellipse at the point of contact (UP2) in the transition to the guide flank (46, 56) forms a load flank angle (LF) with the semi-major axis (HA) of the ellipse which is less than 30°, in particular less than 25°.

51: The screw according to claim 49, wherein the distance of the contact point (UP1) from the semi-major axis (HA) is greater than ⅓*thread height*tan (load flank angle), and the distance of the contact point (UP2) from the semi-major axis (HA) is greater than ⅓*thread height*tan (guide flank angle).

52: The screw according to claim 50, wherein the respective connecting line (VL1; VL2) from the point of contact (UP1; UP2) to the apex (SP) of the semi-major axis (HA) at the thread crest forms an apex angle (VL1-HA, VL2-HA) with the semi-major axis (HA) which is less than 55°, in particular less than 45°.

53: The screw according to claim 30, wherein the thread crest is designed such that an orthogonal to the tangent (T1, T2) at the point of contact (UP1, UP2) intersects the semi-major axis at a point of intersection (BP1; BP2), with the distance between the point of intersection (BP1; BP2) and the transition point (UP1, UP2) being less than 90% of the distance between the apex (SP) and the point of intersection (BP1; BP2).

54: The screw according to claim 50, wherein the transition from the elliptical thread crest (34, 44) to the thread flank (32, 36; 42, 46) is tangential.

55: The screw according to claim 54, wherein the guide flank (46, 56) and/or the load flank (42, 52) runs along an elliptical path which is curved in the opposite direction to the ellipse (SE) forming the thread crest (44, 54).

56: The screw according to claim 55, wherein the numerical eccentricity of the elliptical path of the guide flank (46, 56) and/or the load flank (42, 52) is less than the numerical eccentricity of the ellipse defining the thread crest.

57: The screw according to claim 50, wherein the semi-major axis (HA) of the ellipse (SE) defining the thread crest is inclined by an angle of up to 10° in the direction of the guide flank (46, 56) relative to the normal plane to the screw centerline.

58: The screw according to claim 30, wherein the distance between adjacent thread flanks at 90% of the thread height is more than 0.7 times the pitch and has a flank width there that is less than 0.5 times the thread height.
